(19) United States
(12) Patent Application Publication
(10) Pub. No.: US 2009/0035598 A1
(43) Pub. Date: Feb. 5, 2009

(54) PRODUCT WITH METALLIC FOAM AND METHOD OF MANUFACTURING THE SAME

(75) Inventors: Michael D. Hanna, West Bloomfield, MI (US); Richard M. Kleber, Clarkston, MI (US); Leonid C. Lev, West Bloomfield, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/165,731

(22) Filed: Jul. 1, 2008

Related U.S. Application Data
(60) Provisional application No. 60/953,801, filed on Aug. 3, 2007.

(51) Int. Cl. B32B 5/18; B22D 19/00

(52) U.S. Cl. 428/550; 164/98

(57) ABSTRACT

One embodiment includes a product including a metallic foam portion which may serve to reduce the weight of the product and/or vent the product and/or provide damping.

This application claims the benefit of U.S. Provisional Application No. 60/953,801, filed Aug. 3, 2007.

### TECHNICAL FIELD

The field to which the disclosure generally relates includes a product with metallic foam and methods of manufacturing thereof.

### BACKGROUND

Parts subjected to vibration may produce unwanted or undesirable vibrations. Similarly, a part or component may be set into motion at an undesirable frequency and/or amplitude and for a prolonged period. For example, parts such as brake rotors, brackets, pulleys, brake drums, transmission housings, gears, and other parts may contribute to noise that gets transmitted to the passenger compartment of a vehicle. In an effort to reduce the generation of this noise and thereby its transmission into the passenger compartment, a variety of techniques have been employed, including the use of polymer coatings on engine parts, sound absorbing barriers, and laminated panels having visco elastic layers. The undesirable vibrations in parts or components may occur in a variety of other products including, but not limited to, sporting equipment, household appliances, manufacturing equipment such as lathes, milling/grinding/drilling machines, earth moving equipment, other nonautomotive applications, and components that are subject to dynamic loads and vibration. These components can be manufactured through a variety of means including casting, machining, forging, die-casting, etc.

### SUMMARY OF EXEMPLARY EMBODIMENTS OF THE INVENTION

One embodiment includes a product including a metallic foam portion which may serve to reduce the weight of the product and/or vent the product and/or provide damping.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 illustrates a product according to one embodiment of the invention;

FIG. 2 illustrates a product according to one embodiment of the invention;

FIG. 3 illustrates a product according to one embodiment of the invention;

FIG. 4 illustrates a product according to one embodiment of the invention;

FIG. 5 illustrates a product according to one embodiment of the invention;

FIG. 6 is a sectional view with portions broken away of one embodiment of the invention including an insert;

FIG. 7 is a sectional view with portions broken away of one embodiment of the invention including two spaced apart frictional surfaces of a cast metal body portion;

FIG. 8 is a sectional view with portions broken away of one embodiment of the invention including an insert having a layer thereon to provide a frictional surface or damping;

FIG. 9 is a sectional view with portions broken away of one embodiment of the invention;

FIG. 10 is an enlarged view of one embodiment of the invention;

FIG. 11 is a sectional view with portions broken away of one embodiment of the invention;

FIG. 12 is an enlarged sectional view with portions broken away of one embodiment of the invention;

FIG. 13 is an enlarged sectional view with portions broken away of one embodiment of the invention;

FIG. 14 is an enlarged sectional view with portions broken away of one embodiment of the invention;

FIG. 15 illustrates one embodiment of the invention;

FIG. 16 is a sectional view with portions broken away of one embodiment of the invention;

FIG. 17 is a sectional view with portions broken away of one embodiment of the invention;

FIG. 18 is a plan view with portions broken away illustrating one embodiment of the invention;

FIG. 19 is a sectional view taken along line 19-19 of FIG. 18 illustrating one embodiment of the invention;

FIG. 20 is a sectional view with portions broken away illustrating one embodiment of the invention; and

FIG. 21 is a sectional view, with portions broken away illustrating another embodiment of the invention.

### DETAILED DESCRIPTION OF EXEMPLARY EMBODIMENTS

The following description of the embodiment(s) is merely exemplary in nature and is in no way intended to limit the invention, its application, or uses.

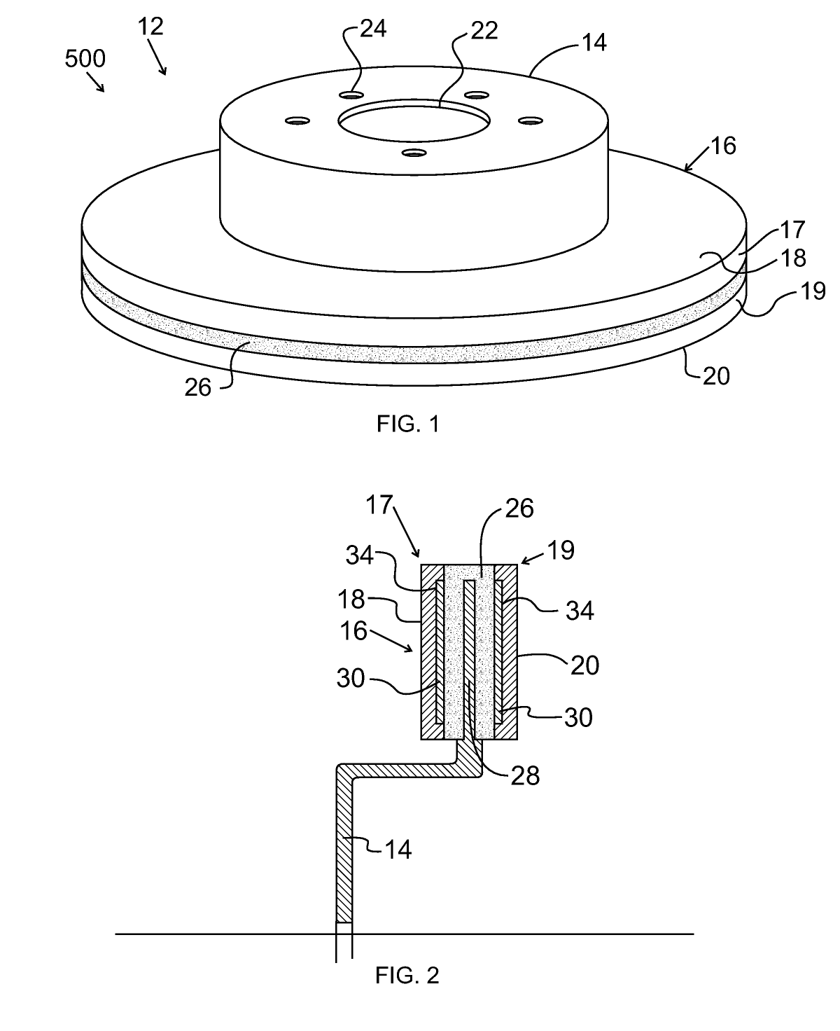

In one embodiment, a part or product 500 is provided as shown in FIG. 1. The part 500 may include any part subject to vibration including, for example, but not limited to a brake rotor, pulley, brake drum, bracket, transmission housing, gear, motor housing, shaft, bearing, engine, baseball bat, lathe machine, milling machine, drilling machine, or grinding machine. In one embodiment the part 500 may be a rotor assembly 12. The rotor assembly 12 may include a hub portion 14 and an annular portion 16. The annular portion 16 may include a first portion (rotor cheek) 17 with a disc brake pad engagement face 18 and a second portion (rotor cheek) 19 with a disc brake pad engagement face 20. In one embodiment, the hub portion 14 may include a central aperture 22. The hub portion 14 may also include a plurality of bolt holes 24. In one embodiment, the annular portion 16 may include at least one metallic foam portion 26. The metallic foam portion 26 may extend between the first portion 17 and the second portion 18 and may be constructed and arranged to allow air to flow therethrough to cool the first portion 17 and the second portion 18. The metallic foam portion 26 may comprise at least one of aluminum, steel, stainless steel, titanium, titanium alloys, magnesium, or other metals or alloys. In one embodiment, the metallic foam portion 26 may have a thickness of about 0.2 mm to about 20 mm. In another embodiment, the metallic foam portion 26 may have a thickness of about 0.5 mm to about 10 mm. The metallic foam portion 26 may reduce the weight of the rotor assembly 12 compared to traditional cast metal vented rotor assemblies. In one embodiment the metallic foam portion 26 may serve to reduce the weight of the part or product 500 and/or vent the part or product 500 and/or provide damping as described hereafter.

In another embodiment, the rotor assembly 12 may be vented and the first portion 17 with the face 18 and the second portion 19 with the face 20 may be separated by a plurality of vanes (not shown). The hub portion 14 may comprise one of aluminum, steel, titanium, stainless steel, cast iron, any of a variety of other alloys, or metal matrix composite. The first portion 17 with the face 18 and the second portion 19 with the face 20 may comprise at least one of aluminum, steel, titanium, stainless steel, cast iron, any of a variety of other alloys, or metal matrix composite. In one embodiment, the faces 18 and 20 may be engaged by a brake pad (not shown) for the application of the braking force of the braking system of an automobile.

Referring to FIG. 2, a cross section of the part or product 500 of FIG. 1 is shown according to one embodiment of the invention. The annular portion 16 further comprises an annular flange 28. The annular flange 28 may contact the metallic foam portion 26. In one embodiment, the annular flange 28 may be encapsulated by the metallic foam portion 26. The flange 28 may serve as at least part of a frictional damping means as described hereafter. The flange 28 and metallic foam portion 26 may move in frictional contact to dissipate any vibration and/or noise of the part 500 in operation. The metallic foam portion 26 may be in contact with at least one of the first portion 17 with the face 18 and the second portion 19 with the face 20. In one embodiment, the metallic foam portion 26 may be coextensive with the faces 18 and 20. In another embodiment, the metallic foam portion 26 may be completely enclosed in the annular portion 16. In one embodiment, the annular portion 16 may include at least one damping insert 30. The insert 30 may be positioned adjacent to at least one of the first portion 17 with the face 18 or the second portion 19 with the face 20. The insert 30 may engage the recess 34 formed in at least one of the first portion 17 with the face 18 or the second portion 19 with the face 20. A layer 520 including particles 514 or fiber, as described in greater detail hereafter, may overlie the insert 30 or metallic foam portion 26.

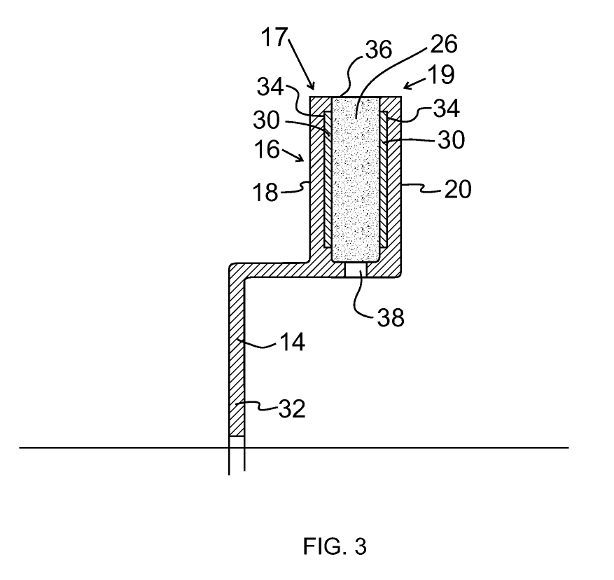

Referring to FIG. 3, one embodiment includes a single piece casting 32 comprising the hub portion 14 and the annular portion 16 comprising the first portion 17 with the face 18 and the second portion 19 with the face 20. The annular portion 16 may include at least one damping insert 30. The insert 30 may be positioned adjacent to at least one of the first portion 17 with the face 18 or the second portion 19 with the face 20. The insert 30 may engage the recess 34 formed in at least one of the first portion 17 with the face 18 or the second portion 19 with the face 20. The annular portion 16 may include at least one metallic foam portion 26. In one embodiment, the metallic foam portion 26 may be molded into a cavity 36 between the first portion 17 with the face 18 and the second portion 19 with the face 20. The metallic foam portion 26 may be molded into the cavity 36 after the single piece casting 32 is prepared and the insert 30 is positioned. The annular portion 16 may also include at least one vent hole 38 that may allow cooling air between the first portion 17 with the face 18 and the second portion 19 with the face 20 through the porosity of the metallic foam portion 26.

In one embodiment of the invention, the insert 30 may not be present. The metallic foam portion 26 may be metallurgically bonded to the first portion 17 and the second portion 19. As such, the metallic foam portion 26 allows the annular portion to be vented. Alternatively, the metallic foam portion 26 may be free to move in frictional contact against the first portion 17 and/or second portion 19, thus serving as a frictional damping means. Additional layers, for example including particles or fibers, may be interposed between the metallic foam portion 26 and the first portion 17 and second portion 19.

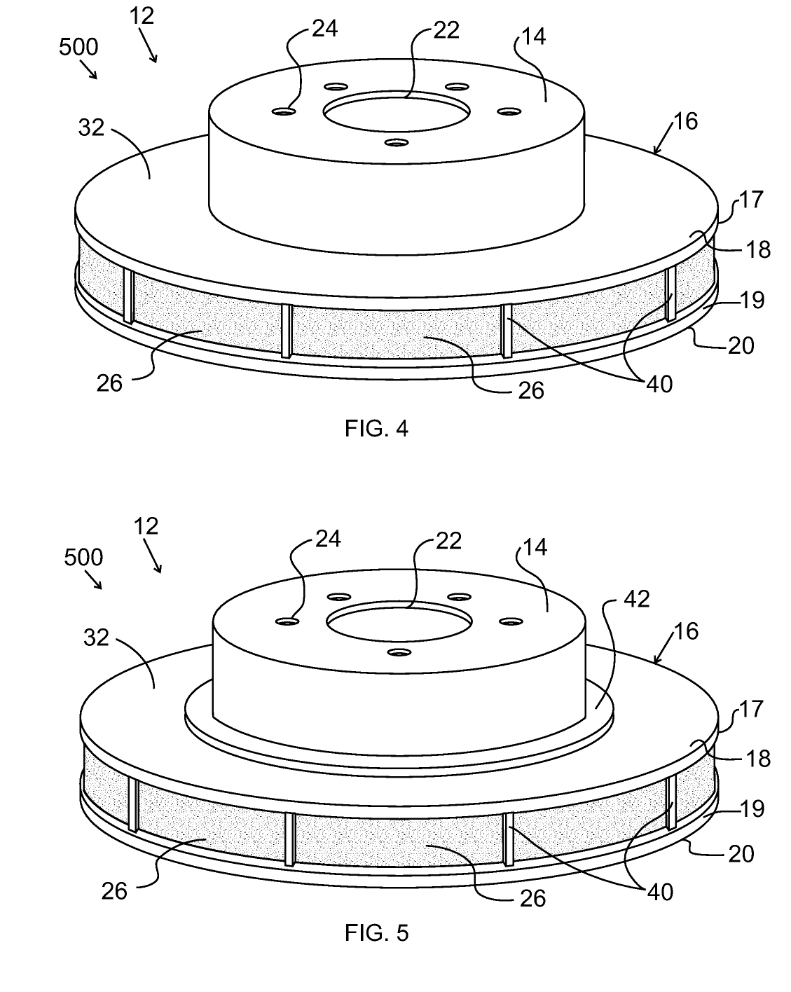

Referring now to FIG. 4, another embodiment of the invention is shown including the part 500. The part 500 may be the rotor assembly 12 and may include the single piece casting 32 comprising the hub portion 14 and the annular portion 16. The annular portion 16 may include the first portion 17 with the face 18 and the second portion 19 with the face 20. A plurality of connecting webs 40 may join the first portion 17 and the second portion 19. In one embodiment, the plurality of connecting webs 40 may be radially oriented. The metallic foam portion 26 may be molded into the area between the plurality of connecting webs 40. In one embodiment, the annular portion 16 may include inserts (not shown) for damping.

Referring now to FIG. 5, another embodiment of the invention is shown including the part 500. The part 500 may be the rotor assembly 12 and may include the hub portion 14 and an annular portion 16. The hub portion 14 may include a flange portion 42. In one embodiment, the hub portion 14 with the flange portion 42 may be cast-in-place.

In another embodiment (not shown), the metallic foam portion 26 may be inlaid in at least one of the first portion 17 with the face 18 or the second portion 19 with the face 20.

In one embodiment, the metallic foam portion 26 is pre-manufactured from at least one of aluminum, steel, stainless steel, titanium, titanium alloys, magnesium, or other metals or alloys. In one embodiment, the metallic foam portion 26 may be manufactured from particles and a foaming agent. In one embodiment, the metallic foam portion 26 may then be clad with at least one of the first portion 17 with the face 18 or the second portion 19 with the face 20. In one embodiment, cladding may include at least one of heat treatment or pressing. In another embodiment, the metallic foam portion 26 may be attached to at least one of the first portion 17 with the face 18 or the second portion 19 with the face 20 using an adhesive, a fastener, metallic bonding, welding, or brazing. In another embodiment, the hub portion 14, the first portion 17 with the face 18, and the second portion 19 with the face 20 are pre-manufactured, and the metallic foam portion 26 is positioned in the space between the first portion 17 and the second portion 19.

In another embodiment, the metallic foam portion 26 is provided and a metal is cast around at least a portion of the metallic foam portion 26.

In another embodiment, the metallic foam portion 26 and the insert 30 are provided and metal is cast around at least a portion of the metallic foam portion 26 and the insert 30. In another embodiment, the hub portion 14 and the annular flange 28 are provided and the metallic foam portion 26 is positioned over at least a portion of the annular flange 28. Then a metal is cast around a portion of the metallic foam portion. In another embodiment, at least one insert 30 is positioned over the metallic foam portion 26 and the metal is then cast around a portion of the metallic foam portion 26 and around a portion of the insert 30. The insert 30 may be constructed and arranged to provide damping.

In various embodiments, the insert 30 may be positioned in the metallic foam portion 26 or the insert 30 may be positioned between the metallic foam portion 26 and at least one of the first portion with the face 18 or the second portion with the face 20. Additional frictional damping means, as described hereafter, may be used in combination with the metallic foam portion 16.

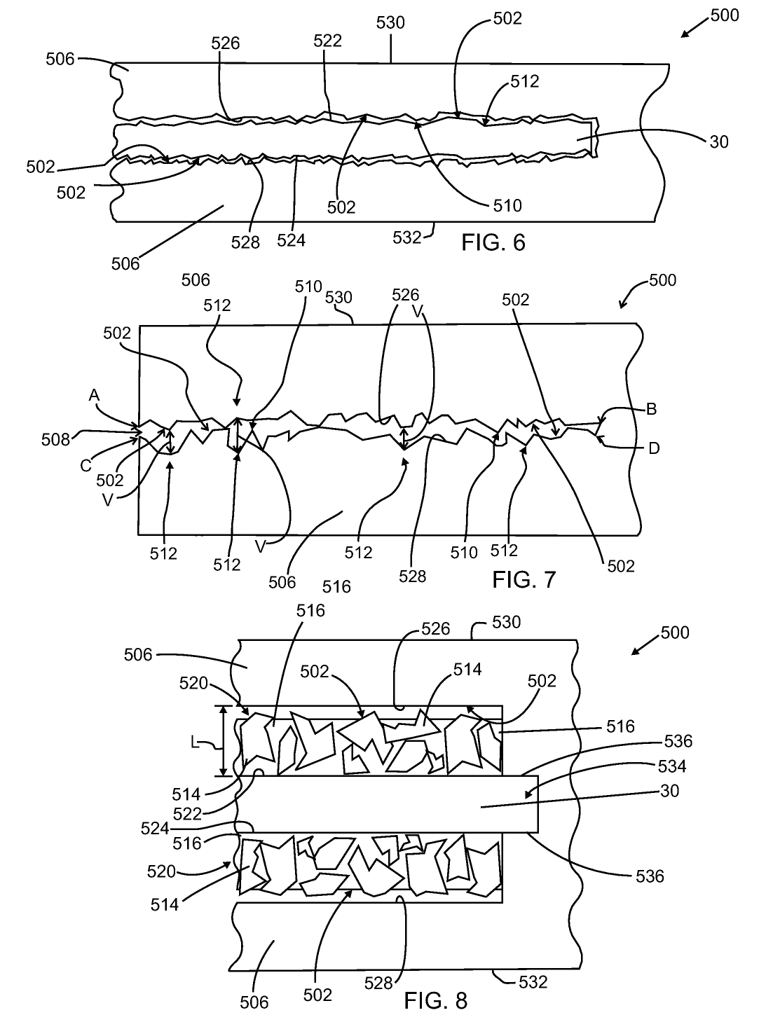

Referring to FIGS. 6-21, one embodiment of the invention includes a product or part 500 having a frictional damping means. The frictional damping means may be used in a variety of applications including, but not limited to, applications where it is desirable to reduce noise associated with a vibrating part or reduce the vibration amplitude and/or duration of a part that is struck, dynamically loaded, excited, or set in motion. In one embodiment the frictional damping means may include an interface boundary conducive to frictionally damping a vibrating part. In one embodiment the damping means may include frictional surfaces 502 constructed and arranged to move relative to each other and in frictional contact, so that vibration of the part is dissipated by frictional damping due to the frictional movement of the surfaces 502 against each other.

According to various illustrative embodiments of the invention, frictional damping may be achieved by the movement of the frictional surfaces 502 against each other. The movement of frictional surfaces 502 against each other may include the movement of: surfaces of the body 506 of the part against each other; a surface of the body 506 of the part against a surface of the insert 30; a surface of the body 506 of the part against the layer 520; a surface of the insert 30 against the layer 520; a surface of the body 506 of the part against the particles 514 or fibers; a surface of the insert 30 against the particles 514 or fibers; or by frictional movement of the particles 514 or fibers against each other or against remaining binder material.

In embodiments wherein the frictional surface 502 is provided as a surface of the body 506 or the insert 30 or a layer 520 over one of the same, the frictional surface 502 may have a minimal area over which frictional contact may occur that may extend in a first direction a minimum distance of 0.1 mm and/or may extend in a second (generally traverse) direction a minimum distance of 0.1 mm. In one embodiment the insert 30 may be an annular body and the area of frictional contact on a frictional surface 502 may extend in an annular direction a distance ranging from about 20 mm to about 1000 mm and in a transverse direction ranging from about 10 mm to about 75 mm. The frictional surface 502 may be provided in a variety of embodiments, for example, as illustrated in FIGS. 6-21.

Referring again to FIG. 6, in another embodiment of the invention one or more of the outer surfaces 522, 524 of the insert 30 or surfaces 526, 528 of the body 506 of the part 500 may include a relatively rough surface including a plurality of peaks 510 and valleys 512 to enhance the frictional damping of the part. In one embodiment, the surface of the insert 30 or the body 506 may be abraded by sandblasting, glass bead blasting, water jet blasting, chemical etching, machining or the like.

As shown in FIG. 7, in one embodiment one frictional surface 502 (for example extending from points A-B) may be a first surface of the body 506 of the part 500 positioned adjacent to a second frictional surface 502 (for example extending from points C-D) of the body 506. The body 506 may include a relatively narrow slot-like feature 508 formed therein so that at least two of the frictional surfaces 502 defining the slot-like feature 508 may engage each other for frictional movement during vibration of the part to provide frictional damping of the part 500. In various embodiments of the invention, the slot-like feature 508 may be formed by machining the cast part, or by using a sacrificial casting insert that may be removed after the casting by, for example, etching or machining. In one embodiment a sacrificial insert may be used that can withstand the temperature of the molten metal during casting but is more easily machined than the cast metal. Each frictional surface 502 may have a plurality of peaks 510 and a plurality of valleys 512. The depth as indicated by line V of the valleys 512 may vary with embodiments. In various embodiments, the average of the depth V of the valleys 512 may range from about 1 μm-300 μm, 50 μm-260 μm, 100 μm-160 μm or variations of these ranges. However, for all cases there is local contact between the opposing frictional surfaces 502 during component operation for frictional damping to occur.

In another embodiment of the invention the damping means or frictional surface 502 may be provided by particles 514 or fibers provided on at least one face of the insert 30 or a surface of the body 506 of the part 500. The particles 514 may have an irregular shape (e.g., not smooth) to enhance frictional damping, as illustrated in FIG. 15. One embodiment of the invention may include a layer 520 including the particles 514 or fibers which may be bonded to each other or to a surface of the body 506 of the part or a surface of the insert 30 due to the inherent bonding properties of the particles 514 or fibers. For example, the bonding properties of the particles 514 or fibers may be such that the particles 514 or fibers may bind to each other or to the surfaces of the body 506 or the insert 30 under compression. In another embodiment of the invention, the particles 514 or the fibers may be treated to provide a coating thereon or to provide functional groups attached thereto to bind the particles together or attach the particles to at least one of a surface of the body 506 or a surface of the insert 30. In another embodiment of the invention, the particles 514 or fibers may be embedded in at least one of the body 506 of the part or the insert 30 to provide the frictional surface 502 (FIGS. 10-11).

In embodiments wherein at least a potion of the part 500 is manufactured such that the insert 30 and/or the particles 514 or fibers are exposed to the temperature of a molten material such as in casting, the insert 30 and/or particles 514 or fibers may be made from materials capable of resisting flow or resisting significant erosion during the manufacturing. For example, the insert 30 and/or the particles 514 or fibers may include refractory materials capable of resisting flow or that do not significantly erode at temperatures above 1100° F., above 2400° F., or above 2700° F. When molten material, such as metal, is cast around the insert 30 and/or the particles 514, the insert 30 or the particles 514 should not be wet by the molten material so that the molten material does not bond to the insert 30 or layer 520 at locations wherein a frictional surface 502 for providing frictional damping is desired.

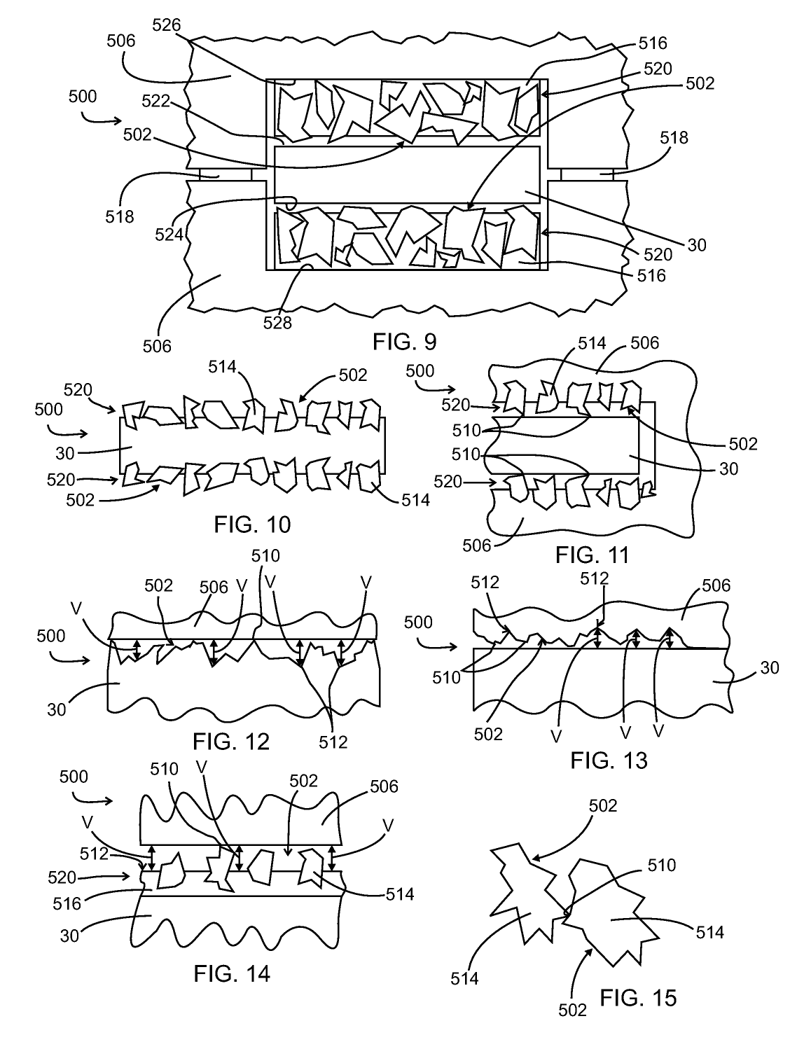

Illustrative examples of suitable particles 514 or fibers include, but are not limited to, particles or fibers including silica, alumina, graphite with clay, silicon carbide, silicon nitride, cordierite (magnesium-iron-aluminum silicate), mullite (aluminum silicate), zirconia (zirconium oxide), phyllosilicates, or other high-temperature-resistant particles. In one embodiment of the invention the particles 514 may have a length along the longest dimension thereof ranging from about 1 μm-350 μm, or 10 μm-250 μm. In embodiments wherein the part 500 is made using a process wherein the insert 30 and/or the particles 514 or fibers are not subjected to relatively high temperatures associated with molten materials, the insert 30 and/or particles 514 or fibers may be made from a variety of other materials including, but not limited to, non-refractory polymeric materials, ceramics, composites, wood or other materials suitable for frictional damping. For example, such non-refractory materials may also be used (in additional to or as a substitute for refractory materials) when two portions of the body 506 of the part 500 are held together mechanically by a locking mechanism, or by fasteners, or by adhesives, or by welding 518, as illustrated in FIG. 9.

In another embodiment of the invention, the layer 520 may be a coating over the body 506 of the part or the insert 30. The coating may include a plurality of particles 514 which may be bonded to each other and/or to the surface of the body 506 of the part or the insert 30 by an inorganic or organic binder 516 (FIGS. 8-9, 14) or other bonding materials. Illustrative examples of suitable binders include, but are not limited to, epoxy resins, phosphoric acid binding agents, calcium aluminates, sodium silicates, wood flour, or clays. In another embodiment of the invention the particles 514 may be held together and/or adhered to the body 506 or the insert 30 by an inorganic binder. In one embodiment, the coating may be deposited on the insert 30 or body 506 as a liquid dispersed mixture of alumina-silicate-based, organically bonded refractory mix.

In another embodiment, the coating may include at least one of alumina or silica particles, mixed with a lignosulfonate binder, cristobalite (SiO₂), quartz, or calcium lignosulfonate. The calcium lignosulfonate may serve as a binder. In one embodiment, the coating may include IronKote. In one embodiment, a liquid coating may be deposited on a portion of the insert and may include high temperature Ladle Kote 310B. In another embodiment, the coating may include at least one of clay, Al₂O₃, SiO₂, a graphite and clay mixture, silicon carbide, silicon nitride, cordierite (magnesium-iron-aluminum silicate), mullite (aluminum silicate), zirconia (zirconium oxide), or phyllosilicates. In one embodiment, the coating may comprise a fiber such as ceramic or mineral fibers.

When the layer 520 including particles 514 or fibers is provided over the insert 30 or the body 506 of the part the thickness L (FIG. 8) of the layer 520, particles 514 and/or fibers may vary. In various embodiments, the thickness L of the layer 520, particles 514 and/or fibers may range from about 1 μm-400 μm, 10 μm-400 μm, 30 μm-300 μm, 30 μm-40 μm, 40 μm-100 μm, 100 μm-120 μm, 120 μm-200 μm, 200 μm-300 μm, 200 μm-250 μm, or variations of these ranges.

In yet another embodiment of the invention the particles 514 or fibers may be temporarily held together and/or to the surface of the insert 30 by a fully or partially sacrificial coating. The sacrificial coating may be consumed by molten metal or burnt off when metal is cast around or over the insert 30. The particles 514 or fibers are left behind trapped between the body 506 of the cast part and the insert 30 to provide a layer 520 consisting of the particles 514 or fibers or consisting essentially of the particles 514 or fibers.

The layer 520 may be provided over the entire insert 30 or only over a portion thereof. In one embodiment of the invention the insert 30 may include a tab 534 (FIG. 8). For example, the insert 30 may include an annular body portion and a tab 534 extending radially inward or outward therefrom. In one embodiment of the invention at least one wettable surface 536 of the tab 534 does not include a layer 520 including particles 514 or fibers, or a wettable material such as graphite is provided over the tab 534, so that the cast metal is bonded to the wettable surface 536 to attach the insert 30 to the body 506 of the part 500 but still allow for frictional damping over the remaining insert surface which is not bonded to the casting.

In one embodiment of the invention at least a portion of the insert 30 is treated or the properties of the insert 30 are such that molten metal will not wet or bond to that portion of the insert 30 upon solidification of the molten metal. According to one embodiment of the invention at least one of the body 506 of the part or the insert 30 includes at least one of a ferrous based material including, but not limited to, cast iron, gray cast iron, steel, or stainless steel, or a nonferrous based material including, but not limited to, aluminum, magnesium, or titanium, or any of a variety of other alloys, or metal matrix composite, or metal matrix composite including abrasive particles. In one embodiment of the invention the insert 30 may include a material such as a metal having a higher melting point than the melting point of the molten material being cast around a portion thereof.

In one embodiment the insert 30 may have a minimum average thickness of 0.2 mm and/or a minimum width of 0.1 mm and/or a minimum length of 0.1 mm. In another embodiment the insert 30 may have a minimum average thickness of 0.2 mm and/or a minimum width of 2 mm and/or a minimum length of 5 mm. In other embodiments the insert 30 may have a thickness ranging from about 0.1-20 mm, 0.1-6.0 mm, or 1.0-2.5 mm, or ranges therebetween.

Referring now to FIGS. 12-13, again the frictional surface 502 may have a plurality of peaks 510 and a plurality of valleys 512. The depth as indicated by line V of the valleys 512 may vary with embodiments. In various embodiments, the average of the depth V of the valleys 512 may range from about 1 μm-300 μm, 50 μm-260 μm, 100 μm-160 μm or variations of these ranges. However, for all cases there is local contact between the body 506 and the insert 30 during component operation for frictional damping to occur.

In other embodiments of the invention improvements in the frictional damping may be achieved by adjusting the thickness (L, as shown in FIG. 8) of the layer 520, or by adjusting the relative position of opposed frictional surfaces 502 or the average depth of the valleys 512 (for example, as illustrate in FIG. 7).

In one embodiment the insert 30 is not pre-loaded or under pre-tension or held in place by tension. In one embodiment the insert 30 is not a spring. Another embodiment of the invention includes a process of casting a material comprising a metal around an insert 30 with the proviso that the frictional surface 502 portion of the insert used to provide frictional damping is not captured and enclosed by a sand core that is placed in the casting mold. In various embodiments the insert 30 or the layer 520 includes at least one frictional surface 502 or two opposite friction surfaces 502 that are completely enclosed by the body 506 of the part. In another embodiment the layer 520 including the particles 514 or fibers that may be completely enclosed by the body 506 of the part or completely enclosed by the body 506 and the insert 30, and wherein at least one of the body 506 or the insert 30 comprises a metal or consists essentially of a metal. In one embodiment of the invention the layer 520 and/or insert 30 does not include or is not carbon paper or cloth.

Referring again to FIGS. 6-9, in various embodiments of the invention the insert 30 may include a first face 522 and an opposite second face 524 and the body 506 of the part may include a first inner face 526 adjacent the first face 522 of the insert 30 constructed to be complementary thereto, for example nominally parallel thereto. The body 506 of the part includes a second inner face 528 adjacent to the second face 524 of the insert 30 constructed to be complementary thereto, for example parallel thereto. The body 506 may include a first outer face 530 overlying the first face 522 of the insert 30 constructed to be complementary thereto, for example parallel thereto. The body 506 may include a first outer face 532 overlying the second face 524 of the insert 30 constructed to be complementary thereto, for example parallel thereto. However, in other embodiments of the invention the outer faces 530, 532 of the body 506 are not complementary to associated faces 522, 524 of the insert 30. When the damping means is provided by a narrow slot-like feature 508 formed in the body 506 of the part 500, the slot-like feature 508 may be defined in part by a first inner face 526 and a second inner face 528 which may be constructed to be complementary to each other, for example parallel to each other. In other embodiments the surfaces 526 and 528; 526 and 522; or 528 and 524 are mating surfaces but not parallel to each other.

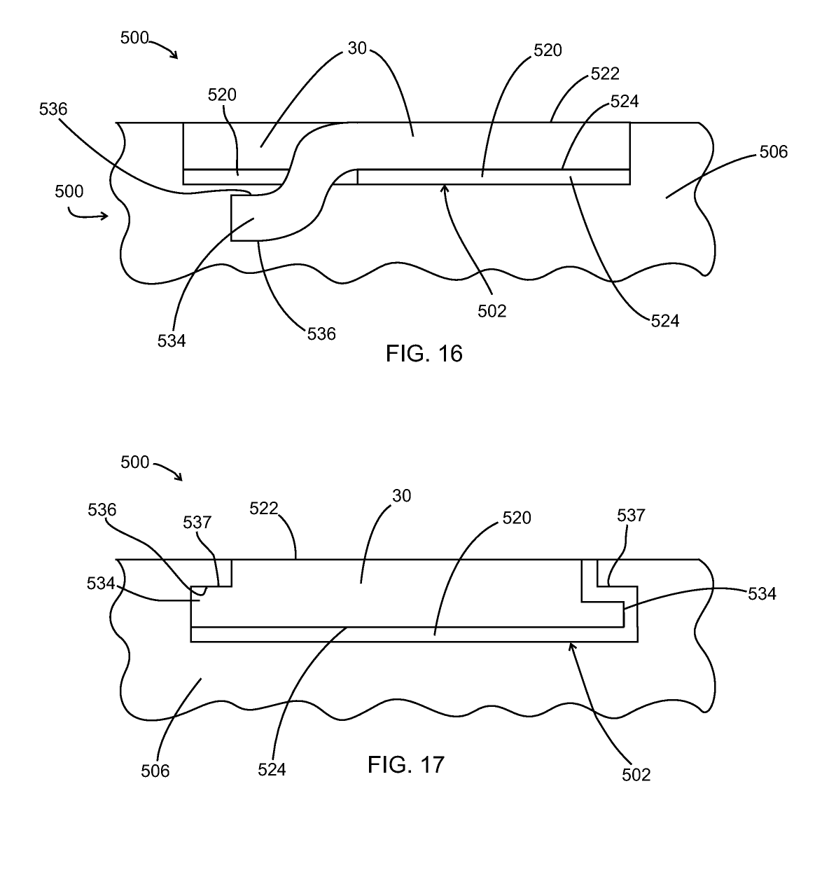

Referring to FIGS. 16-17, in one embodiment of the invention the insert 30 may be an inlay wherein a first face 522 thereof is not enclosed by the body 506 of the part. The insert 30 may include a tang or tab 534 which may be bent downward as shown in FIG. 16. In one embodiment of the invention a wettable surface 536 may be provided that does not include a layer 520 including particles 514 or fibers, or a wettable material such as graphite is provided over the tab 534, so that the cast metal is bonded to the wettable surface 536 to attach the insert 30 to the body of the part but still allow for frictional damping on the non-bonded surfaces. A layer 520 including particles 514 or fibers may underlie the portion of the second face 524 of the insert 30 not used to make the bent tab 534.

In another embodiment the insert 30 includes a tab 534 which may be formed by machining a portion of the first face 522 of the insert 30 (FIG. 17). The tab 534 may include a wettable surface 536 having cast metal bonded thereto to attach the insert 30 to the body of the part but still allow for friction damping by way of the non-bonded surfaces. A layer 520 including particles 514 or fibers may underlie the entire second face 524 or a portion thereof. In other embodiments of the invention all surfaces including the tabs 534 may be non-wettable, for example by way of a coating 520 thereon, and features of the body portion 506 such as, but not limited to, a shoulder 537 may be used to hold the insert 30 in place.

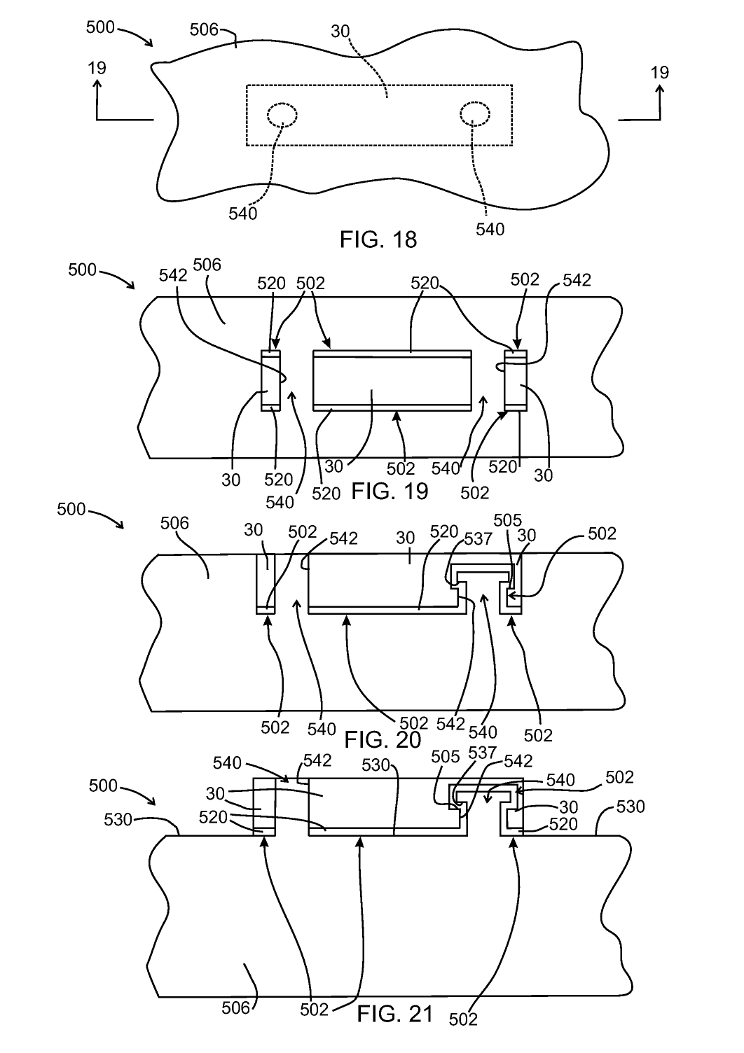

Referring now to FIG. 18, one embodiment of the invention may include a part 500 having a body portion 506 and an insert 30 enclosed by the body part 506. The insert 30 may include through holes formed therein so that a stake or post 540 extends into or through the insert 30.

Referring to FIG. 19, which is a sectional view of FIG. 18 taken along line 19-19, in one embodiment of the invention a layer 520 including a plurality of particles 514 or fibers (not shown) may be provided over at least a portion of the insert 30 to provide a frictional surface 502 and to prevent bonding thereto by cast metal. The insert 30 including the layer 520 may be placed in a casting mold and molten metal may be poured into the casting mold and solidified to form the post 540 extending through the insert 30. An inner surface 542 defining the through hole of the insert 30 may be free of the layer 520 or may include a wettable material thereon so that the post 540 is bonded to the insert 30. Alternatively, in another embodiment the post 30 may not be bonded the insert 30 at the inner surface 542. The insert 30 may include a feature such as, but not limited to, a shoulder 505 and/or the post 540 may include a feature such as, but not limited to, a shoulder 537 to hold the insert in place.

Referring now to FIG. 20, in another embodiment, the insert may be provided as an inlay in a casting including a body portion 506 and may include a post 540 extending into or through the insert 30. The insert 30 may be bonded to the post 540 to hold the insert in place and still allow for frictional damping. In one embodiment of the invention the insert 30 may include a recess defined by an inner surface 542 of the insert 30 and a post 540 may extend into the insert 30 but not extend through the insert 30. In one embodiment the post 30 may not be bonded to the insert 30 at the inner surface 542. The insert 30 may include a feature such as, but not limited to, a shoulder 505 and/or the post 540 may include a feature such as, but not limited to, a shoulder 537 to hold the insert in place.

Referring now to FIG. 21, in another embodiment of the invention, an insert 30 or substrate may be provided over an outer surface 530 of the body portion 506. A layer 520 may or may not be provided between the insert 30 and the outer surface 530. The insert 30 may be constructed and arranged with through holes formed therethrough or a recess therein so that cast metal may extend into or through the insert 30 to form a post 540 to hold the insert in position and still allow for frictional damping. The post 540 may or may not be bonded to the insert 30 as desired. The post 540 may extend through the insert 30 and join another portion of the body 506 if desired.

When the term “over,” “overlying,” overlies,” “under,” “underlying,” or “underlies” is used herein to describe the relative position of a first layer or component with respect to a second layer or component such shall mean the first layer or component is directly on and in direct contact with the second layer or component or that additional layers or components may be interposed between the first layer or component and the second layer or component.

The above description of embodiments of the invention is merely exemplary in nature and, thus, variations thereof are not to be regarded as a departure from the spirit and scope of the invention.

What is claimed is:

1. A product comprising:
a metallic foam portion;
a first portion comprising a face; and
a second portion comprising a face, the metallic foam extending between the first portion and the second portion and constructed and arranged to allow air to flow therethrough to cool the first portion and the second portion.

2. A product as set forth in claim 1 wherein the metallic foam portion comprises at least one of aluminum, steel, stainless steel, titanium, titanium alloys, or magnesium.

3. A product as set forth in claim 2 wherein the metallic foam portion is clad with a metallic portion.

4. A product as set forth in claim 3 wherein the metallic portion is the first portion comprising the face.

5. A product as set forth in claim 3 wherein the metallic portion is the second portion comprising the face.

6. A product as set forth in claim 1 further comprising an insert.

7. A product as set forth in claim 6 further comprising a coating over at least a portion of the insert.

8. A product as set forth in claim 6 wherein the insert comprises a layer comprising particles or fibers over a portion of the insert.

9. A product as set forth in claim 6 wherein the metallic foam portion is constructed and arranged to frictionally damp the product.

10. A product as set forth in claim 1 further comprising a layer comprising particles or fibers overlying the metallic foam portion.

11. A product as set forth in claim 1 further comprising:
an annular portion comprising a first portion and the second portion;
a hub portion; and
an insert constructed and arranged to damp the product.

12. A product as set forth in claim 11 further comprising a flange extending from the hub portion and positioned between the first portion and the second portion.

13. A product as set forth in claim 12 wherein the flange is constructed and arranged to frictionally damp the product.

14. A product as set forth in claim 12 wherein the metallic foam portion surrounds at least a portion of the flange.

15. A product as set forth in claim 1 wherein the metallic foam portion is also constructed and arranged to damp the product.

16. A product as set forth in claim 1 wherein the thickness of the metallic foam portion is about 0.2 mm to about 20 mm.

17. A product as set forth in claim 1 wherein the thickness of the metallic foam portion is about 0.5 mm to about 10 mm.

18. A damped product comprising:
a first portion;
a second portion;
a metallic foam portion positioned between the first portion and the second portion;
a first cavity formed in one of the first portion and second portion; and
an insert at least partially received in the first cavity so that the first portion and second portion completely enclose the damping insert and so that vibration of the product is damped by the insert.

19. A method comprising:
providing a metallic foam portion; and
casting a metal around a portion of the metallic foam portion.

20. A method as set forth in claim 19 further comprising providing at least one insert and casting the metal around a portion of the metallic foam portion and around a portion of the insert, wherein the insert is constructed and arranged to provide damping.

21. A method comprising:
providing a hub portion and an annular flange;
positioning a metallic foam portion over at least a portion of the annular flange; and
casting a metal around a portion of the metallic foam portion to provide a product.

22. A method as set forth in claim 21 further comprising positioning at least one insert over the metallic foam portion and casting the metal around a portion of the metallic foam portion and around a portion of the insert, wherein the insert is constructed and arranged to provide damping of the product.

23. A method as set forth in claim 21 wherein the annular flange is constructed and arranged to provide damping of the product.

24. A method as set forth in claim 21 wherein the metallic foam is constructed and arranged to provide damping of the product.
